(19) United States
(12) Patent Application Publication
(10) Pub. No.: US 2008/0238931 A1
(43) Pub. Date: Oct. 2, 2008

(54) Video signal processing device, video signal processing method, and video display system

(75) Inventors: Yasuhiro Komiya, Tokyo (JP); Hiroyuki Fukuda, Tokyo (JP); Takuji Horie, Sagamihara-shi (JP); Akira Matsushita, Tokyo (JP); Takeyuki Ajito, Tokyo (JP); Ken Ioka, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/079,619

(22) Filed: Mar. 27, 2008

(30) Foreign Application Priority Data
Mar. 30, 2007 (JP) 2007-91069

(51) Int. Cl. G09G 5/02

(52) U.S. Cl. 345/589

(57) ABSTRACT

A video signal processing device which processes a video signal input into a display monitor inputs illumination profile information relating to an illumination spectral characteristic of a light source and monitor profile information relating to a display profile of the display monitor. A video signal conversion unit performs color conversion processing on the input video signal on the basis of the illumination profile information and monitor profile information, and outputs a video display signal to the display monitor. As a result, color correction is performed on a video image displayed on the display monitor.

### BACKGROUND OF THE INVENTION

1. Field of the Invention

This invention relates to a video display technique that enables accurate color reproduction of an object using a color display device.

2. Description of the Related Art

Various methods have been proposed as techniques enabling accurate color reproduction of an object using a color display device. In a device disclosed in JP2001-60082A, the color characteristics of a color display device (display profile) and the illumination conditions of the environment in which the color display device is placed (observation illumination information) are obtained. Image data transmitted from an image server via a network are then adjusted on the basis of the observation illumination information and display profile, whereupon a video image is displayed. With this configuration, it is possible to simulate the tones of a product in the illumination environment in which a customer views the color display device during electronic shopping via a network, for example. As a result, inconvenience caused when the customer orders the product but then returns the product after the product has arrived, claiming that the color of the product is different to the expected color, can be suppressed.

A different technique to that described above also exists. Specifically, “Eye-One” is known as a tool for adjusting the tones of a video image displayed on a color display device by measuring the color characteristics of the color display device and the illumination conditions of the environment in which the color display device is placed. “Eye-One” is a tool for performing color management. By using “Eye-One”, the effect of coloring differences due to differences among the manufacturers of the color display device, differences between models, individual differences, and so on can be reduced such that the tones of an image displayed on the basis of identical image data appear substantially identical, irrespective of differences in the color display devices. The display profile is obtained by attaching (adhering) a sensor unit having an inbuilt colorimeter to the top of the color display device during calibration of the color display device, and measuring the color reproducibility of the color patches displayed on the color display device.

The sensor unit also comprises a sensor that measures illumination light (ambient light) illuminating the space where the color display device is placed. The tones of the displayed video image are adjusted using the display profile obtained in the manner described above and the ambient light measurement result, whereby the color characteristics of the color display device become neutral. Furthermore, the effects of ambient light are reduced in the following manner. When the eyes of a viewer viewing the video image displayed on the color display device adapt to the ambient light (to be referred to in this specification as “ambient light adaptation”) or when ambient light is reflected on a display surface of the color display device (to be referred to in this specification as “display surface reflection”, the tones of the video image displayed on the color display device may appear to deviate from a neutral state. By adjusting the tones of the displayed video image on the basis of the ambient light measurement result, the effects of ambient light described above can be reduced.

### SUMMARY OF THE INVENTION

In the constitution described above, a sensor for measuring the display profile and a sensor for measuring the ambient light must be provided, leading to an increase in cost. Furthermore, calibrating the color display device in the manner described above in order to use the color display device (display monitor) is undeniably troublesome for the user. Moreover, when the color management tool described above is not used correctly, the tones of the video image displayed on the color display device may not be as desired.

It is an object of the present invention to provide means for solving the problems described above. It is also an object of the present invention to provide a technique enabling the colors of an object to be reproduced and displayed accurately at low cost and without forcing a user to perform complicated operations, without the use of a sensor or the like for detecting the color characteristics of a display and ambient light characteristics.

According to a first aspect of this invention, a video signal processing device for processing a video signal input into a display monitor comprises: an illumination profile information input unit that inputs illumination profile information, which is information relating to an illumination spectral characteristic of an illumination device that illuminates the periphery of the display monitor, from the illumination device; a monitor profile information input unit that inputs monitor profile information, which is information relating to a display profile of the display monitor, from the display monitor; and a video signal conversion unit that performs color correction on a video image displayed on the display monitor by performing the video signal to color conversion processing on the basis of the illumination profile information and the monitor profile information.

According to a second aspect of this invention, a video signal processing method for processing a video signal input into a display monitor comprises: inputting illumination profile information, which is information relating to an illumination spectral characteristic of an illumination device that illuminates the periphery of the display monitor, from the illumination device; inputting monitor profile information, which is information relating to a display profile of the display monitor, from the display monitor; and performing color correction on a video image displayed on the display monitor by performing the video signal to color conversion processing on the basis of the illumination profile information and the monitor profile information.

According to a third aspect of this invention, this invention is also applied to a video display system. The video display system comprises: a display monitor that displays a video image and is capable of outputting monitor profile information, which is information relating to a display profile of the display monitor, an illumination device that illuminates the periphery of the display monitor and is capable of outputting illumination profile information, which is information relating to an illumination spectral characteristic of the illumination device; an illumination profile information input unit that inputs the illumination profile information; a monitor profile information input unit that inputs the monitor profile information; and a video signal processing unit that is configured to perform color correction on the video image displayed on the display monitor by performing an input video signal to color conversion processing on the basis of the illumination profile information and monitor profile information input by the illumination profile information input unit and monitor profile information input unit, respectively.

### BRIEF DESCRIPTION OF THE DRAWINGS

Detailed description of embodiments of the inventions will be made with reference to the accompanying drawings.

FIG. 1 is a block diagram illustrating the schematic configuration of a video display system according to a first embodiment of this invention.

FIG. 2 is a block diagram illustrating an example of the internal configuration of a video signal conversion unit.

FIG. 3 is a block diagram illustrating an example of the internal configuration of a color conversion processing unit and a monitor color conversion unit.

FIG. 4 is a block diagram illustrating an example in which a video signal processing device is incorporated into a display monitor.

FIG. 5 is a view illustrating an example in which an illumination profile information receiving unit is disposed on an upper portion of the display monitor.

FIG. 6 is a block diagram illustrating a constitutional example in which a plurality of light sources of different types are provided.

FIG. 7 is a block diagram illustrating the schematic configuration of a video display system according to a second embodiment of this invention.

FIG. 8 is a graph illustrating an example of a relationship between the elapsed time following a cold start of an illumination device and the illumination brightness of the illumination device.

FIG. 9 is a graph showing an example of the manner in which an illumination spectrum of the illumination device varies as a cumulative ON time of the illumination device varies from initial use.

FIG. 10 is a block diagram illustrating the schematic configuration of a video display system according to a third embodiment of this invention.

FIG. 11 is a block diagram illustrating an example of the internal configuration of an illumination profile information correction unit.

FIG. 12 is a block diagram illustrating an example of the internal configuration of a monitor profile information correction unit.

FIG. 13 is a block diagram illustrating another example of the internal configuration of the monitor profile information correction unit.

FIG. 14 is a block diagram illustrating an example in which an elapsed time measurement unit that measures elapsed time following the start of use of the light source is provided in the illumination device.

### DETAILED DESCRIPTION OF THE PREFERRED EMBODIMENTS

### First Embodiment

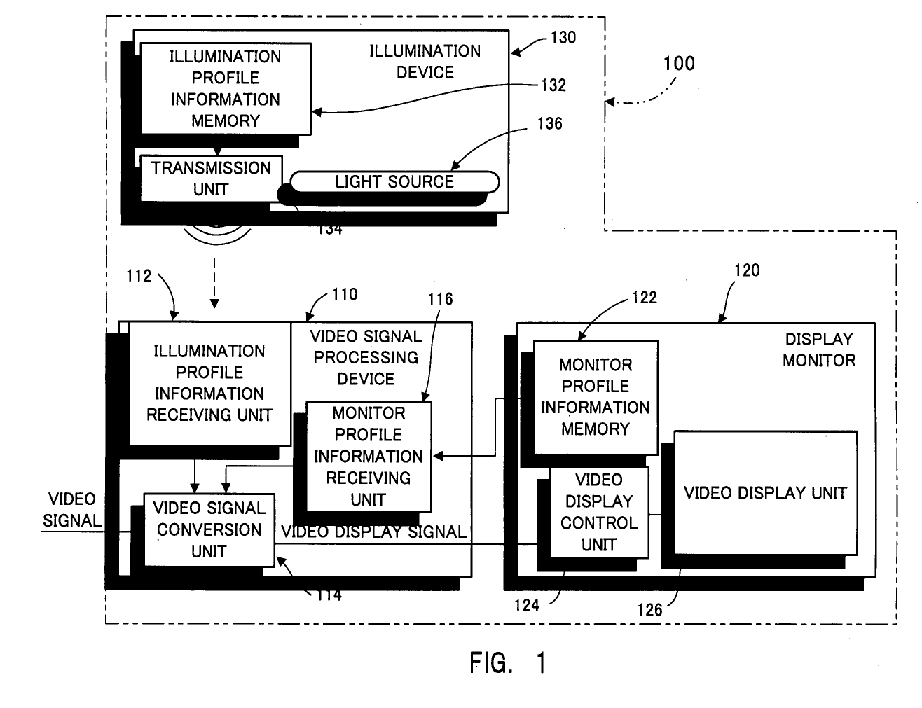

FIG. 1 is a block diagram showing the schematic configuration of a video display system 100 according to a first embodiment of this invention. The video display system 100 comprises a display monitor 120, an illumination device 130 for illuminating the (indoor) periphery of the display monitor 120, and a video signal processing device 110 for processing an input video signal and outputting the processed video signal to the display monitor 120.

The illumination device 130 comprises a light source 136 that emits illumination light, an illumination profile information memory 132 that stores illumination profile information, which is information relating to illumination spectral characteristics of the light source 136, and a transmission unit 134 configured to be capable of outputting a signal including the illumination profile information using a wireless technique such as radio waves, light, or acoustic waves. Data expressing the spectral characteristics of the light source 136 in a visible wavelength band of 380 nm to 780 nm may be used as the illumination profile information, for example. When data recorded with a spectral characteristic at 1 nm intervals within the aforementioned visible wavelength band are employed, for example, 401 sets of data between 2 and 4 bytes are collected.

The light source 136 can be exchanged as needed, similarly to a conventional illumination device. The illumination profile information is stored in the illumination profile information memory 132 in accordance with the type of the attached light source 136 (for example, an incandescent lamp, a halogen lamp, an LED, a fluorescent lamp having an illumination profile such as a high color rendering profile, a daylight profile, or a tungsten light profile, and so on), the manufacturer, the product type, and so on. When the illumination device according to this embodiment of the invention comprises a lamp cover or the like, the lamp cover or the like preferably does not affect, or only slightly affects, the spectral characteristics of the illumination light that is directed toward the illuminated portion. However, when the cover or the like does affect the spectral characteristics of the illumination light, it is desirable either that the spectral characteristics of the lamp cover or the like be taken into account in the illumination profile information stored in the illumination profile information memory 132, or that these spectral characteristics be taken into account in the illumination profile information included in the signal output from the transmission unit 134.

The display monitor 120 comprises a video display unit 126 employing any one of an LDC, a CRT, a PDP, an FED (Field Emission Display), an organic EL, a projector, and so on, a video display control unit 124 that performs control such that a video image based on a video display signal input into the display monitor 120 is displayed on the video display unit 126, and a monitor profile information memory 122 that stores monitor profile information, which is information relating to the display profile of the display monitor 120. Information relating to the chromaticity, tone profile, and so on of the video display unit 126 may be included in the monitor profile information.

The video signal processing device 110 comprises an illumination profile information receiving unit 112, a monitor profile information receiving unit 116, and a video signal conversion unit 114. The illumination profile information receiving unit 112 receives a signal output by the transmission unit 134 of the illumination device 130 via radio waves, light, acoustic waves, and so on, separates the illumination profile information from the received signal, and outputs the information to the video signal conversion unit 114. The monitor profile information receiving unit 116 receives a signal including the monitor profile information stored in the monitor profile information memory 122 in a wired or wireless manner from the display monitor 120, separates the monitor profile information from the received signal, and outputs the information to the video signal conversion unit 114.

The video signal conversion unit 114 performs color conversion processing, to be described below, on a video signal input into the video signal conversion unit 114 on the basis of the illumination profile information and monitor profile information input from the illumination profile information receiving unit 112 and monitor profile information receiving unit 116, as described above, and outputs a video display signal to the display monitor 120. In addition to image data required to display a video image, the video signal includes object illumination information relating to the illumination illuminating the object when the image was captured, image capturing device information, header information, and so on. The object illumination information includes illumination light data at the time of image capture, or in other words data relating to the illumination light spectrum and the color temperature of the illumination light at the time of image capture. The image capturing device information includes data relating to the spectral sensitivity characteristic of the camera (image capturing device) used for image capture, the F number of the imaging lens, the focal distance, and so on. The header information includes information such as the format version of the image data, the header size, the file format, and the image size. In this specification, the object illumination information, image capturing device information and so on will be referred to together as input profile information.

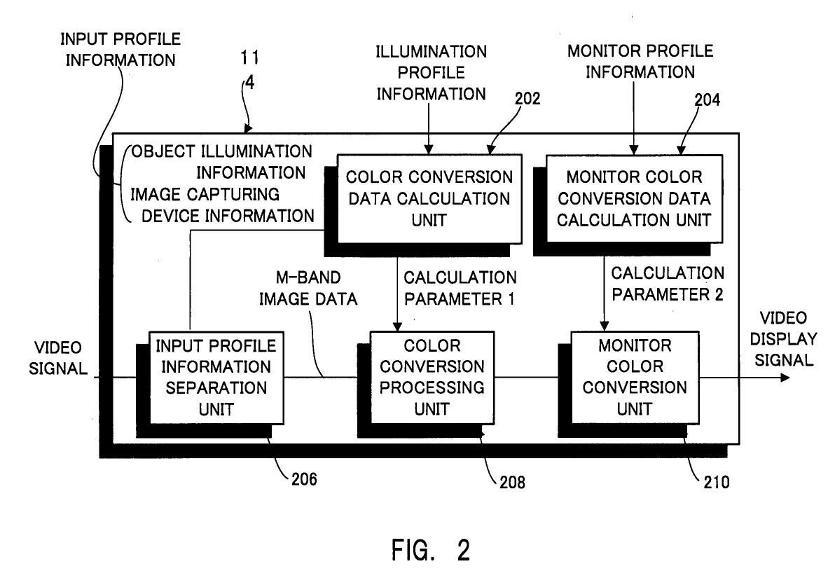

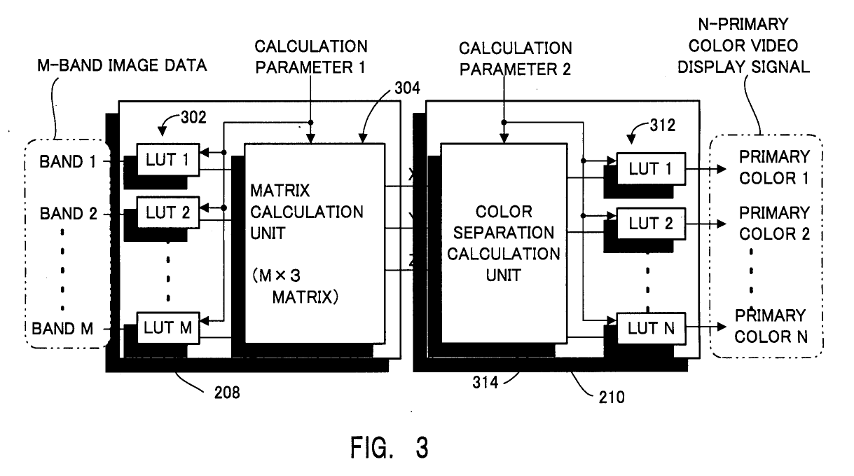

FIG. 2 shows the detailed configuration of the video signal conversion unit 114, while FIG. 3 shows the detailed configuration of a color conversion processing unit 208 and a monitor color conversion unit 210 included in the video signal conversion unit 114.

As shown in FIG. 2, the video signal conversion unit 114 comprises a color conversion data calculation unit 202, a monitor color conversion data calculation unit 204, a input profile information separation unit 206, the color conversion processing unit 208, and the monitor color conversion unit 210. The input profile information separation unit 206 processes an input image signal to separate the aforementioned input profile information from the image data. It should be noted that in the following description, it is assumed that the image data separated by the input profile information separation unit are image data consisting of M bands.

The color conversion data calculation unit 202 determines a calculation parameter (to be referred to hereafter as a “calculation parameter 1”) to be used in color conversion processing of the image data from the input profile information input from the input profile information separation unit 206 and the illumination profile information input from the illumination profile information receiving unit 112, and outputs the determined calculation parameter 1 to the color conversion processing unit 208.

The color conversion processing unit 208 performs color conversion processing on the M-band image data input from the input profile information separation unit 206 on the basis of the calculation parameter 1 input from the color conversion data calculation unit 202, thereby generating XYZ color system image signals, or in other words colorimetric-value video signals. This processing will be described in detail below with reference to FIG. 3. It should be noted that hereafter, only an example in which the color conversion processing unit 208 generates XYZ colorimetric-value video signals will be described, but an sRGB color system or an xvYCC color system may be used as the signals generated by the color conversion processing unit 208 through conversion of the M-band image data.

On the basis of the monitor profile information input from the monitor profile information receiving unit 116, the monitor color conversion data calculation unit 204 determines a calculation parameter (to be referred to hereafter as a “calculation parameter 2”) to be used in color conversion processing by the monitor color conversion unit 210 to generate the colorimetric-value video signals (to be described below). The monitor color conversion data calculation unit 204 then outputs the determined calculation parameter 2 to the monitor color conversion unit 210.

The monitor color conversion unit 210 separates (converts) the XYZ colorimetric-value video signals input from the color conversion processing unit 208 into N-primary color video display signals. The monitor color conversion unit 210 also performs correction processing corresponding to the chromaticity and gamma characteristic of the display monitor. This processing will be described in detail below with reference to FIG. 3.

As described above, the video signal conversion unit 114 separates M-band image data from the input video signal, performs color conversion processing on the M-band image data using the calculation parameter 1 determined on the basis of the input profile information and the illumination profile information, and thereby generates colorimetric-value video signals. The video signal conversion unit 114 also corrects the chromaticity and gamma by separating the colorimetric-value video signals into N-primary color video display signals using the calculation parameter 2 determined on the basis of the monitor profile information, and outputs the corrected N-primary color video display signals to the display monitor 120. It should be noted that in this invention, the values of M and N in the aforementioned M bands and N primary colors are typically assumed to be 3 or more.

FIG. 3 is a block diagram illustrating in detail the color conversion processing unit 208 and the monitor color conversion unit 210. Lookup tables LUT 1, LUT 2, . . . , LUT M (to be referred to together as a “LUT 302” hereafter) corresponding respectively to the input M-band image data and an M×3 matrix in a matrix calculation unit 304 are generated from the calculation parameter 1 input into the color conversion processing unit 208. Using the LUT 302, so-called tone curve correction is performed on the M-band image data to remove the effect of a level/gamma characteristics of the camera. Next, the matrix calculation unit 304 performs a matrix calculation on the M-band image data to convert the M-band image data into XYZ colorimetric-value video signals. In the processing of the color conversion processing unit 208 described above, color conversion is performed to simulate the coloring of the object when illuminated by the illumination device 130. More specifically, the illumination profile of the illumination device that illuminates the disposed location of the display monitor on which the viewer views video images is reflected in the colors of the displayed video image such that the coloring of the displayed object simulates as if the object were placed at the disposed location of the display monitor. Furthermore, during this color conversion processing, the effects of ambient light adaptation and display surface reflection can be reduced, as described above.

A data table for a color separation calculation unit 314, which is used to separate the three-band (XYZ) video signals input into the monitor color conversion unit 210 into video display signals consisting of from primary color 1 to primary color N, and lookup tables LUT 1, LUT 2, . . . , LUT N (to be referred to hereafter as a “LUT 312”) corresponding respectively to the N-primary color signals output from the color separation calculation unit 314 are generated from the calculation parameter 2 input into the monitor color conversion unit 210. The data table generated for use in the color separation calculation unit 314 may be formed as a 3×3 matrix when the video display signals are output in three primary colors. When the video display signals are output in four or more primary colors, a lookup table for generating video display signals in four or more primary colors from the three-band video signals input into the monitor color conversion unit 210 is generated in the color separation calculation unit 314. The LUT 312 is used to correct the gamma characteristic of the display monitor 120.

The video signal processing device 110 described above may be implemented as a so-called set-top box that is disposed on the upper portion of the display monitor 120 or the like. In this case, the video signal processing device 110 may be built into a conventional cable television set-top box or provided as a set-top box having only a video signal processing function.

The video signal processing device 110 may also be built into an appliance that is connected to the display monitor 120 so as to be capable of recording and reproducing video images. Examples of appliances that are capable of reproducing or recording and reproducing video images include a playback-only appliance for DVD, HD-DVD, Blu-ray Disk, and so on, a recording and playback appliance employing a recording medium such as DVD, HD-DVD, or Blu-ray Disk, and so on.

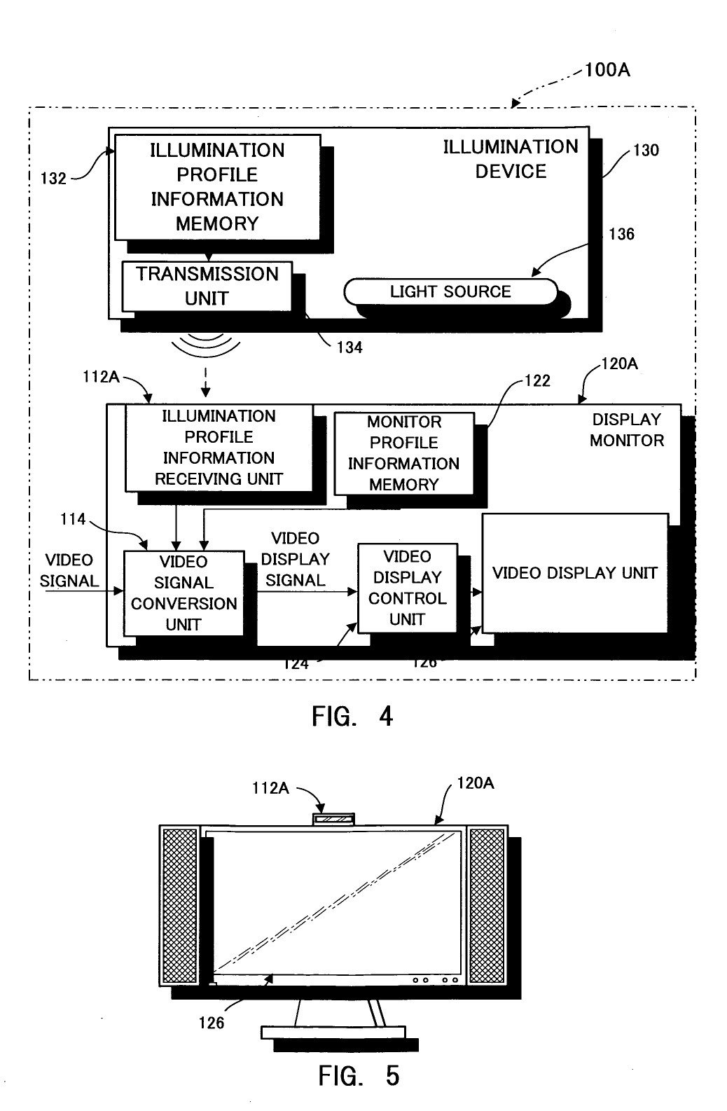

In the example described above, the video signal processing device 110 is provided as an external appliance disposed on the exterior of the display monitor 120, but the video signal processing device may be built into the display monitor 120. An example of this will now be described with reference to FIGS. 4 and 5. In a video display system 100A shown in FIG. 4, identical components to those of the system shown in FIG. 1 have been allocated identical reference symbols, and description thereof has been omitted. Further, components having basically identical functions but differing slightly in their internal configuration, the manner in which they are disposed, and so on have been allocated identical reference numerals with the addition of an alphabetic character such as A or B, and detailed description thereof has been omitted.

In FIG. 4, an illumination profile information receiving unit 112A is built into or attached to a display monitor 120A. FIG. 5 shows an example of this. In the display monitor 120A shown in FIG. 5, the illumination profile information receiving unit 112A is attached to a top surface part of a casing of the display monitor 120A so as to be capable of receiving signals output from the transmission unit 134 of the illumination device 130. Returning to FIG. 4, the video signal conversion unit 114 is built into the display monitor 120A, and therefore the monitor profile information receiving unit 116 provided in the video signal processing device 110 of FIG. 1 is omitted, and the monitor profile information memory 122 is directly connected to the video signal conversion unit 114.

When the video signal processing device 110 is provided as an external appliance, as shown in FIG. 1, a video display system exhibiting superior color reproducibility can be constructed simply by purchasing the video processing device 110 separately and connecting it to a previously purchased video appliance. As a result, the performance of the video display system can be improved at minimal cost. On the other hand, when the video processing device is built into the display monitor 120A, as shown in FIG. 4, the user need not worry about how and where to connect the device. In addition, the overall manufacturing cost of the video display system can be reduced, and an aesthetically pleasing video display system can be provided.

In the embodiment described above, the timing at which signals are output from the transmission unit 134 of the illumination device 130 was not mentioned, but signals may be output at predetermined time intervals of 10 seconds, 30 seconds, one minute, or ten minutes. Alternatively, a receiver and a transmitter may be provided additionally on the illumination device 130 side and the video signal processing device 110 side, respectively, such that whenever a signal requesting illumination profile information is issued from the video signal processing device 110, the information is output from the illumination device 130.

In the example described above, wireless technology is used to transfer the illumination profile information between the illumination device 130 and the video signal processing device 110 or between the illumination device 130 and the display monitor 120A, but information transfer may be performed using a wired system. In this case, information transfer may be performed using power-line carrier (PLC) technology.

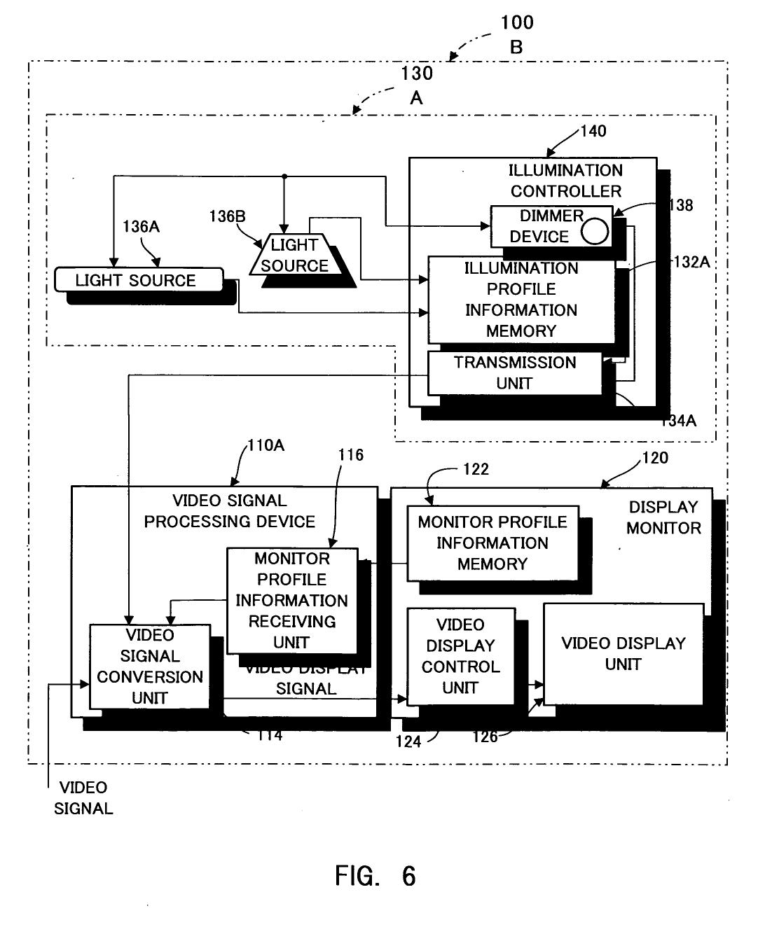

Further, in the example described above, either a single light source 136 or a plurality of light sources of the same type is provided, as shown in FIG. 1, for example, but when a plurality of types of illumination device are disposed in the room in which the display monitor 120 is disposed, this invention may be implemented in a manner to be described below with reference to FIG. 6. A video display system 100B shown in FIG. 6 comprises light sources 136A and 136B having different illumination spectra. For example, the light source 136A may be a daylight fluorescent lamp used as a main light, and the light source 136B may be a halogen lamp used as a down light. In the video display system 100B shown in FIG. 6, identical components to those of the video display system 100 shown in FIG. 1 have been allocated identical reference symbols, and description thereof has been omitted. Further, components having basically identical functions but differing slightly in their internal configuration, the manner in which they are disposed, and so on have been allocated identical reference numerals with the addition of an alphabetic character such as A or B, and detailed description thereof has been omitted.

The light sources 136A and 136B are connected to an illumination controller 140. The illumination controller 140 comprises a dimmer device 138, an illumination profile information memory 132A, and a transmission unit 134A. The illumination spectrum information of the light sources 136A and 136B is stored in the illumination profile information memory 132A. The viewer of the display monitor 120 can control the light sources 136A and 136B ON and OFF and adjust the light quantity of the light sources 136A and 136B when they are switched ON by operating the dimmer device 138. Further, when both of the light sources 136A and 136B are ON, the illuminance ratio between the two light sources can be varied arbitrarily. Information relating to the ON/OFF state and illuminance of the respective light sources 136A, 136B is output to the transmission unit 134A from the dimmer device 138. The transmission unit 134A of the illumination controller 140 and the video signal conversion unit 114 of a video signal processing device 110A may be connected either by a wired or wireless manner, but in the example shown in FIG. 6, the transmission unit 134A and video signal conversion unit 114 are connected by a wired communication system such as PLC. The transmission unit 134A calculates an overall illumination spectrum of the light sources illuminating the periphery of the display monitor 120 from the aforementioned information output from the dimmer device 138 and the illumination spectrum information of the respective light sources 136A and 136B output from the illumination profile information memory 132A, and outputs illumination profile information corresponding to the calculated illumination spectrum to the video signal conversion unit 114. The video signal processing device 110A performs color conversion processing on the video signal on the basis of the input illumination profile information and monitor profile information using the method described above. It should be noted that in relation to FIG. 6, an example in which the illumination device 130A comprises two types of light sources 136A and 136B was described, but three or more types of light sources may be provided.

In the first embodiment described above, illumination profile information, which is information relating to the illumination spectral characteristics of the illumination device that illuminates the periphery of the display monitor, is input from the illumination device, and monitor profile information, which is information relating to the display profile of the display monitor, is input from the display monitor, whereupon color correction is performed on the video image displayed on the display monitor by performing the video signal to color conversion processing on the basis of the illumination profile information and monitor profile information. Hence, the color reproducibility of the video image displayed on the display monitor can be improved by means of a simple and low-cost configuration. In other words, the color reproducibility of the video image displayed on the display monitor can be improved without providing a sensor for detecting the display profile of the display monitor and a sensor for detecting the spectral characteristics of the illumination device that illuminates the periphery of the display monitor.

### Second Embodiment

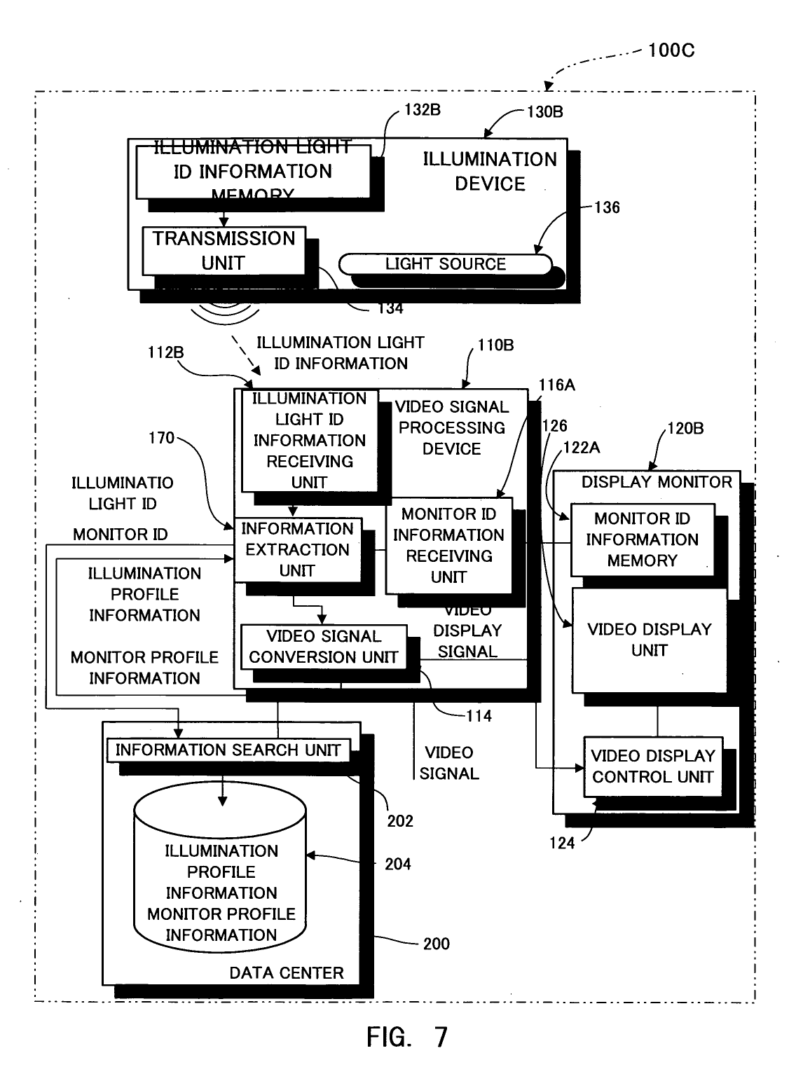

FIG. 7 is a block diagram showing the schematic configuration of a video display system 100C according to a second embodiment of this invention. In the video display system 100C shown in FIG. 7, identical components to those of the video display system 100 according to the first embodiment shown in FIG. 1 have been allocated identical reference symbols, and description thereof has been omitted. Further, components having identical functions and differing only in their internal configuration, the manner in which they are disposed, and so on have been allocated identical reference numerals with the addition of an alphabetic character such as A or B, and detailed description thereof has been omitted.

In the video display system 100 according to the first embodiment, shown in FIG. 1, the illumination profile information is exchanged between the transmission unit 134 of the illumination device 130 and the illumination profile information receiving unit 112 of the video signal processing device 110, and the monitor profile information is communicated between the monitor profile information memory 122 of the display monitor 120 and the monitor profile information receiving unit 116 of the video signal processing device 110. Therefore, the amount of exchanged information reaches several kilobytes, which is comparatively large. In the video display system according to the second embodiment, on the other hand, only illumination light ID information and monitor ID information, or in other words product specification information from which the manufacturer, model number and so on of the light source (light bulb, fluorescent tube, or similar) 136 attached to an illumination device 130B and a display monitor 120B can be specified, are communicated, and therefore the data quantity can be reduced greatly.

The video display system 100C according to the second embodiment will be described below, focusing on differences with the video display system 100 according to the first embodiment shown in FIG. 1.

The illumination device 130B comprises an illumination light ID information memory 132B that stores illumination light ID information, which is product specification information relating to the attached light source 136. The display monitor 120B comprises a monitor ID information memory 122A that stores monitor ID information, which is product specification information relating to the display monitor 120B. The illumination light ID information and monitor ID information are information being capable of uniquely specifying the model of the light source 136 which light source the user can obtain.

An illumination light ID information receiving unit 112B, a monitor ID information receiving unit 116A, and an information extraction unit 170 provided in the video signal processing device 110B will now be described. The illumination light ID information receiving unit 112B receives a signal including the illumination light ID information from the transmission unit 134 through wireless communication means, separates the illumination light ID information from the signal, and outputs the separated illumination light ID information to the information extraction unit 170. The monitor ID information receiving unit 116A receives a signal including the monitor ID information from the display monitor 120B, separates the monitor ID information from the signal, and outputs the separated monitor ID information to the information extraction unit 170.

The information extraction unit 170 extracts the illumination profile information and monitor profile information on the basis of the input illumination light ID information and monitor ID information in the following manner. The information extraction unit 170 accesses a remote data center 200 via the Internet or the like. The information extraction unit 170 then transmits the illumination light ID information and monitor ID information to an information search unit 202 of the data center 200. The data center 200 has a database 204 that stores illumination light ID information and illumination profile information corresponding to the light source (light bulb, fluorescent tube, etc.) specified by the illumination light ID information, as well as monitor ID information and monitor profile information corresponding to the display monitor specified by the monitor ID information, exhaustively. The information search unit 202 accesses the database 204, searches for the illumination profile information and monitor profile information that correspond to the illumination light ID information and monitor ID information transmitted from the information extraction unit 170, and transmits the obtained illumination profile information and monitor profile information to the information extraction unit 170.

The information extraction unit 170 outputs the input illumination profile information and monitor profile information to the video signal conversion unit 114, whereupon the video signal conversion unit 114 performs similar processing to that described in the first embodiment with reference to FIG. 1 on the input video signal.

As described above, in the video display system 100C according to the second embodiment, only the illumination light ID information and monitor ID information are communicated between the video signal processing device 110B and the illumination device 130B and display monitor 120B, and therefore the data quantity during information communication between the illumination device 130B and the video signal processing device 110B and between the display monitor 120B and the video signal processing device 110B can be reduced. Furthermore, the illumination light ID information memory 132B and monitor ID information memory 122A only require a small storage capacity, and therefore the respective configurations of the illumination device 130B and display monitor 120B can be simplified.

In the example described above, the information extraction unit 170 accesses the remote data center 200, but the database 204 in the data center 200 and the information search unit 202 may be built into the video signal processing device 110B. In this case, transmitted data that have been superimposed onto a terrestrial digital broadcast signal, for example, are stored successively in the database such that the database can be constantly updated to the latest version in accordance with the launch of new illumination devices (light sources) and monitors or the discontinuation of an illumination device (light source) or monitor. Alternatively, the video signal processing device 110B may be connected to the Internet so as to obtain data corresponding to a newly launched illumination device or display monitor from a predetermined data center.

Further, when a video signal is transmitted from a data center via the Internet or the like as part of a Video On Demand (VOD) service or the like, the data center may be provided with the equivalent of the video signal processing device 110B. In this case, the data center receives the illumination light ID information and monitor ID information from a client, or in other words the video signal reception side, whereupon video signal color conversion processing is performed on the data center side on the basis of this information. Since a video signal that has already been subjected to color conversion processing is received, the processing of the video signal conversion unit. 114 on the client side is no longer required.

Furthermore, when each appliance is connected to the Internet and has its own unique IP address, in accordance with the popularization of IPv6, an IP address may be used in place of the illumination ID information and monitor ID information, and both the monitor profile information and the illumination profile information may be searched for and extracted from the IP address. Further, when a unique address or identification code such as a MAC address is allocated to each appliance instead of a unique IP address, corresponding illumination profile information and monitor profile information may be searched for and extracted on the basis of the address or code.

In the video display system 100C according to the second embodiment of this invention, similarly to the first embodiment described above, a signal including the illumination light ID information may be communicated between the illumination device 130B and the video signal processing device 110B using a wired system. Furthermore, the video signal processing device 110B may be built into the display monitor 120B. Moreover, similarly to the aspect described with reference to FIG. 6, the video display system 100C according to the second embodiment may comprise a plurality of types of light sources having different illumination spectra.

### Third Embodiment

It is known that the illumination spectrum of the light source (fluorescent tube or the like) of the illumination device varies as time elapses from the start of use. The following two types of variation may be cited as the main causes of this variation in the illumination spectrum. Firstly, variation occurs as a result of warm-up following a cold start, and secondly, variation is caused by light source deterioration occurring as the cumulative ON time increases following initial use in a new condition.

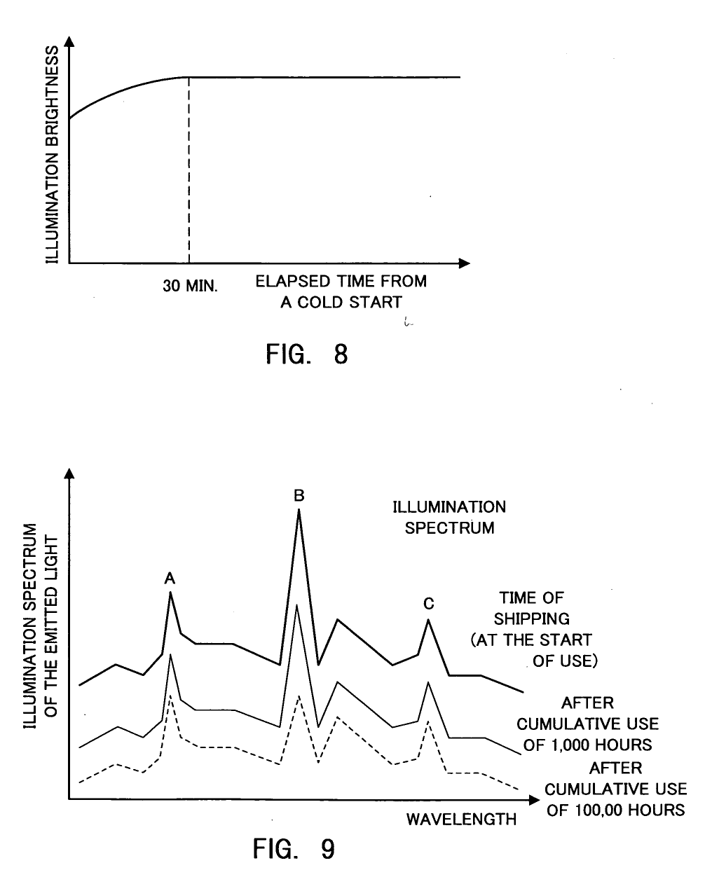

FIG. 8 shows an example of the manner in which the brightness (illumination brightness) of the light emitted from the light source varies over time from a cold start, i.e. when the light source is switched ON after cooling to approximately room temperature during a period of non-use. In the example of FIG. 8, maximum brightness is reached approximately 30 minutes after the cold start, whereupon the brightness stabilizes. As the brightness varies, the illumination spectrum also varies. The display monitor exhibits a similar characteristic. In the example shown in FIG. 8, a steady state is reached approximately 30 minutes after the cold start, but this is also affected by the room temperature (the temperature around the light source and display monitor), and as the room temperature increases, the illumination brightness immediately after the cold start tends to increase, thereby reducing the time required to reach a steady state.

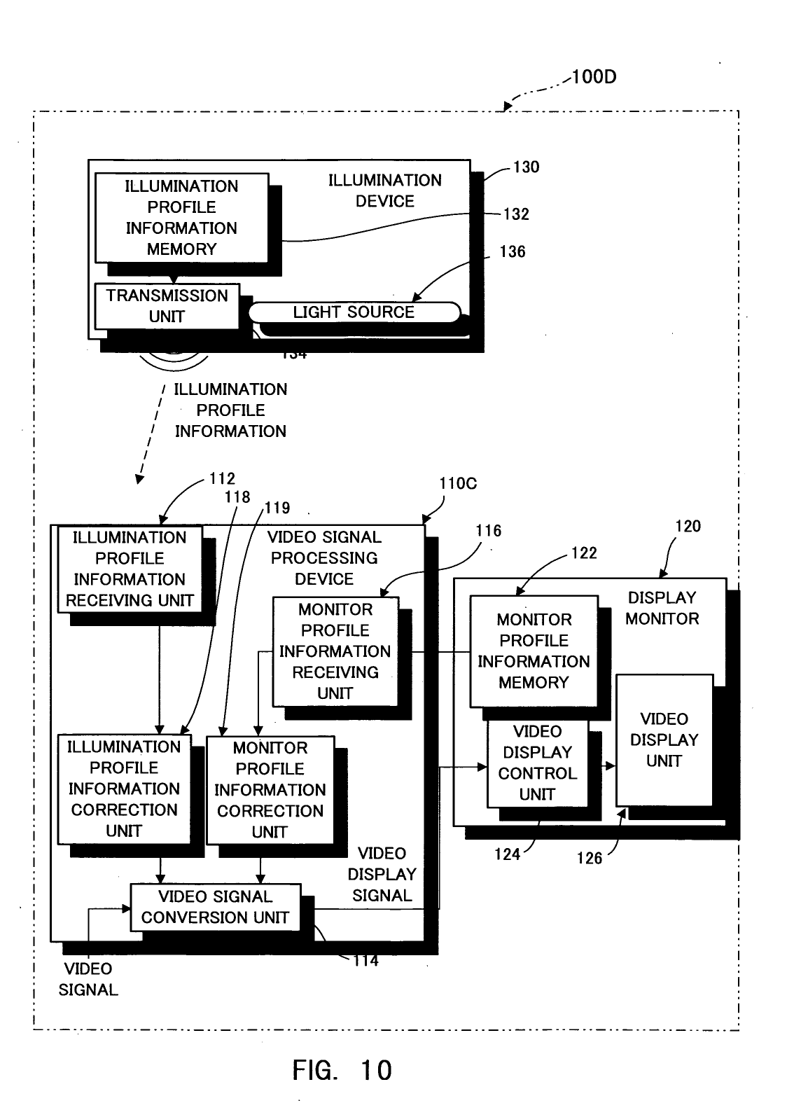

FIG. 9 shows an example of the manner in which the illumination spectrum of the emitted light varies due to light source deterioration occurring as a cumulative value of the ON time of the light source (in this specification, referred to simply as the “cumulative ON time”) increases following initial use in a new condition (at the time of shipping). Typically, the brightness tends to decrease as the cumulative ON time increases from a new condition (from the time of shipping), and as the brightness varies, the emission spectrum also varies. In the example shown in FIG. 9, three large peaks A, B and C occur at the start of use, or in other words when the cumulative ON time is near zero, but as the cumulative ON time increases to 1,000 hours and then 10,000 hours, the overall brightness decreases. In addition, the brightness of the peak B decreases at a greater rate than the brightness of the peak A and the peak C. Since the emission spectrum varies in accordance with increases in the cumulative ON time in this manner, the video image displayed on the display monitor is preferably subjected to color correction in consideration of this variation.

FIG. 10 is a block diagram showing the schematic configuration of a video display system 100D according to a third embodiment of this invention. In the video display system 100D shown in FIG. 10, identical components to those of the video display system 100 according to the first embodiment shown in FIG. 1 have been allocated identical reference symbols, and description thereof has been omitted. Further, components having identical functions and differing only in their internal configuration, the manner in which they are disposed, and so on have been allocated identical reference numerals with the addition of an alphabetic character such as A or B, and detailed description thereof has been omitted.

In the video display system 100D shown in FIG. 10, the illumination profile information output from the illumination profile information receiving unit 112 and the monitor profile information output from the monitor profile information receiving unit 116 are corrected in the manner to be described in detail below to eliminate the temporal and temperature factors described above.

A video signal processing device 110C shown in FIG. 10 differs from the video signal processing device 110 shown in FIG. 1 in further comprising an illumination profile information correction unit 118 and a monitor profile information correction unit 119. The illumination profile information is output to the illumination profile information correction unit 118 from the illumination profile information receiving unit 112, and the monitor profile information is output to the monitor profile information correction unit 119 from the monitor profile information receiving unit 116. The illumination profile information is corrected by the illumination profile information correction unit 118, whereupon the corrected illumination profile information is output to the video signal conversion unit 114, as will be described in detail below. The monitor profile information is corrected by the monitor profile information correction unit 119, whereupon the corrected monitor profile information is output to the video signal conversion unit 114, as will be described in detail below.

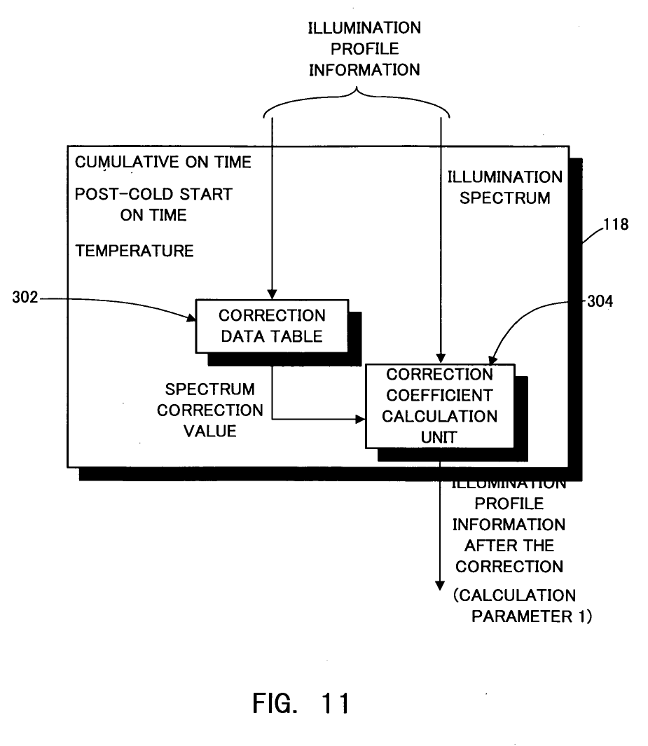

FIG. 11 is a block diagram showing the schematic internal configuration of the illumination profile information correction unit 118. The illumination profile information correction unit 118 comprises a correction data table 302 and a correction coefficient calculation unit 304. Data for correcting the illumination spectrum information of the light source 136 in accordance with the cumulative ON time, the ON time following a cold start, and the peripheral temperature of the light source are stored in the correction data table 302. For example, correction coefficients respectively corresponding to wavelengths in wavelength intervals of 1 nm, 10 nm or 100 nm are stored. Of the illumination profile information input into the illumination profile information correction unit 118, information relating to the cumulative ON time, the ON time following a cold start, and the peripheral temperature of the light source is input into the correction data table 302, whereupon a correction coefficient corresponding to this information is extracted and output to the correction coefficient calculation unit 304. Of the illumination profile information input into the illumination profile information correction unit 118, information relating to the illumination spectrum of the light source 136 is input into the correction coefficient calculation unit 304 together with the aforementioned correction coefficient, whereupon the correction coefficient calculation unit 304 performs processing to correct the illumination spectrum-related information. For example, the correction coefficient calculation unit 304 performs processing to multiply the illumination spectrum-related information by the correction coefficient. The corrected illumination profile information (corresponding to the calculation parameter 1 of FIGS. 2 and 3) is then output to the video signal conversion unit 114 from the illumination profile information correction unit 118.

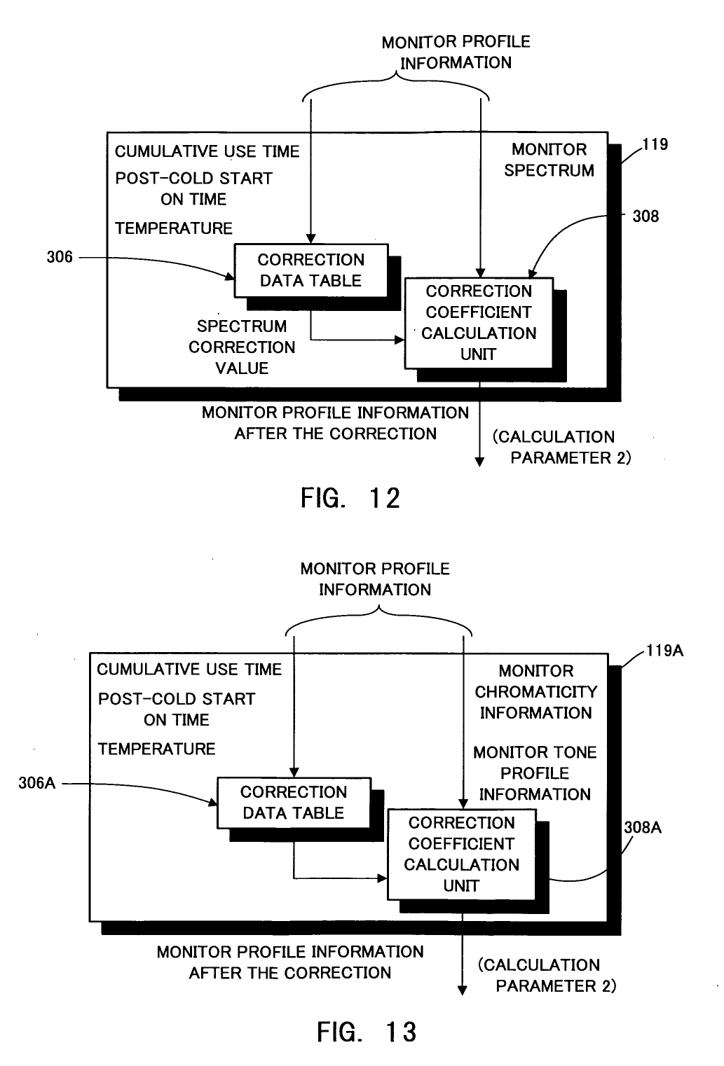

FIG. 12 is a block diagram showing an example of the schematic internal configuration of the monitor profile information correction unit 119. The monitor profile information correction unit 119 comprises a correction data table 306 and a correction coefficient calculation unit 308. Data for adding corrections to the monitor spectrum information of the display monitor 120 in accordance with a cumulative value of the actual operating time of the monitor from initial use in a new condition (referred to in this specification as the “cumulative use time”), the elapsed time following a cold start, and the peripheral temperature of the display monitor are stored in the correction data table 306. For example, when the display monitor is a normal RGB input monitor, emission spectrum information for the three colors red, blue and green is stored. When the monitor is an RGB input LCD monitor, for example, a fluorescent tube serving as a backlight is often used. In this case, the illumination spectral characteristics of the backlight vary as the cumulative use time increases, as shown in FIG. 9. Therefore, a similar correction coefficient to that stored in the correction data table 302 of the illumination profile information correction unit 118 may be stored. Of the monitor profile information input into the monitor profile information correction unit 119, information relating to the cumulative use time, the elapsed time following a cold start, and the peripheral temperature of the display monitor is input into the correction data table 306, whereupon a correction coefficient corresponding to this information is extracted and output to the correction coefficient calculation unit 308. Of the monitor profile information input into the monitor profile information correction unit 119, information relating to the monitor spectrum of the display monitor 120 is input into the correction coefficient calculation unit 308 together with the aforementioned correction coefficient, whereupon the correction coefficient calculation unit 308 performs processing to correct the monitor spectrum-related information. For example, the correction coefficient calculation unit 308 performs processing to multiply the monitor spectrum-related information by the correction coefficient. The corrected monitor profile information (corresponding to the calculation parameter 2 of FIGS. 2 and 3) is then output to the video signal conversion unit 114 from the monitor profile information correction unit 119.

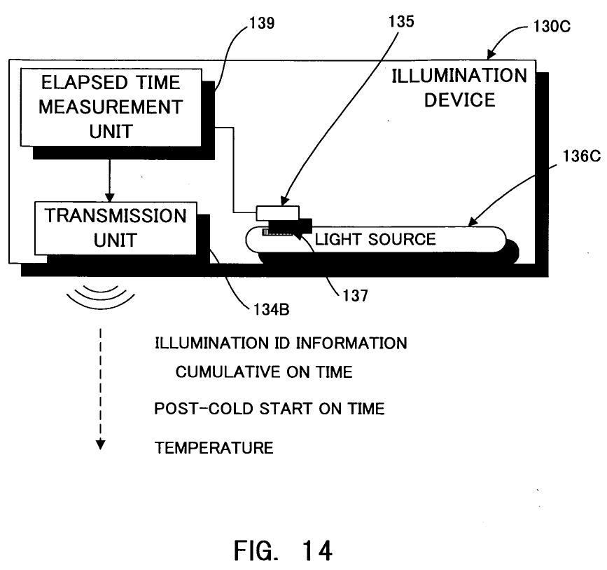

FIG. 13 is a block diagram showing another example of the schematic internal configuration of the monitor profile information correction unit. A monitor profile information correction unit 119A comprises a correction data table 306A and a correction coefficient calculation unit 308A. Data for adding corrections to monitor chromaticity information and monitor tone profile information of the display monitor 120 in accordance with the cumulative use time of the display monitor, the elapsed time following a cold start, and the peripheral temperature of the display monitor are stored in the correction data table 306A. When the display monitor is a normal RGB input monitor, the monitor chromaticity information may include XYZ values for each of the colors red, blue and green, for example. The monitor tone profile information is information expressing a relationship between the magnitude of an input signal input into the display monitor and the output (display brightness), and may also be referred to as gamma characteristic information. The tone profile (gamma characteristic) differs in each of the three colors red, blue and green. Of the monitor profile information input into the monitor profile information correction unit 119A, information relating to the cumulative use time, the elapsed time following a cold start, and the peripheral temperature of the display monitor is input into the correction data table 306A, whereupon a correction coefficient corresponding to this information is extracted and output to the correction coefficient calculation unit 308A. Of the monitor profile information input into the monitor profile information correction unit 119A, information relating to the monitor chromaticity and monitor tone profile of the display monitor 120 is input into the correction coefficient calculation unit 308A together with the aforementioned correction coefficient, whereupon the correction coefficient calculation unit 308A performs processing to correct the monitor chromaticity and monitor tone profile-related information. For example, the correction coefficient calculation unit 308A is capable of performing addition/subtraction or multiplication/division on the aforementioned XYZ value information relating to the monitor chromaticity using the correction coefficient output from the correction data table 306A. Similarly, the correction coefficient calculation unit 308A is capable of adding a modification to the monitor chromaticity-related information and monitor tone profile-related information by means of addition/subtraction using the correction coefficient output from the correction data table 306A. The corrected monitor profile information (corresponding to the calculation parameter 2 of FIGS. 2 and 3) can then be output to the video signal conversion unit 114 from the monitor profile information correction unit 119A.

A method of measuring the cumulative ON time and post-cold start ON time of the light source 136 and the cumulative use time and post-cold start elapsed time of the display monitor 120 will now be described. When the video signal processing device 110C is kept in a constantly ON state, the video signal processing device 110C is capable of monitoring the operational state of the illumination device 130 and display monitor 120. For example, the operational states of the illumination device 130 and the display monitor 120 may be monitored by the illumination profile information receiving unit 112 and the monitor profile information reception 116, respectively, to measure the cumulative ON time and post-cold start ON time of the light source 136 and the cumulative use time and post-cold start elapsed time of the display monitor 120, whereupon the measurement results are output to the illumination profile information correction unit 118 and the monitor profile information correction unit 119. In this case, the measurement results are preferably initialized by operating a switch, a remote controller, or the like (not shown) provided on the video signal processing device 110C when the viewer replaces the light source 136 or the display monitor 120 with a new one.

FIG. 14 is a block diagram showing an example in which the illumination device 130 comprises an elapsed time measurement unit 139 for measuring the cumulative ON time and post-cold start ON time of the light source. The illumination device 130C shown in FIG. 14 comprises an illumination ID information reading device 135, the elapsed time measurement unit 139, and a transmission unit 134B. The illumination ID information reading device 135 is configured to be capable of reading illumination ID information 137 provided to the light source 136C. When the illumination ID information 137 provided to the light source 136C takes the form of alphabetic characters, a bar code, a two-dimensional bar code, or similar, a device capable of image input, such as a camera module, may be used as the illumination ID information reading device 135. Alternatively, when the illumination ID information 137 provided to the light source 136C is an IC tag (RFID tag) or the like, a reader capable of receiving an RF signal may be used as the illumination ID information reading device 135. Further, in an embodiment where the type of light source 136C that can be attached to the illumination device 130C is limited to several types, a microswitch, a photoreflector or the like may be used as the illumination ID information reading device 135 such that the type of the light source 136C can be specified by detecting a notch, a projection, a reflector, a pattern or the like provided on the light source 136C as the illumination ID information 137.

The illumination ID information output from the illumination ID information reading device 135 is input into the elapsed time measurement unit 139. The elapsed time measurement unit 139 is capable of determining whether or not the light source 136C has been replaced on the basis of the presence or absence of information output from the illumination ID information reading device 135. More specifically, when the illumination ID information read by the illumination ID information reading device 135 varies or the illumination ID information becomes readable after being unreadable for a predetermined time period or more, for example ten seconds or more, the elapsed time measurement unit 139 can determine that the light source 136C has been replaced with a new one. The elapsed time measurement unit 139 is also capable of determining that the light source 136C has been cold-started when the elapsed time (interval) between the last time the light source 136C was switched OFF to the next time the light source 136C is switched ON reaches or exceeds fifteen minutes, for example. On the basis of these determination results, the elapsed time measurement unit 139 measures the cumulative ON time and post-cold start ON time of the light source 136C, and outputs the measurement results to the transmission unit 134B together with the illumination ID information. At this time, information relating to the peripheral temperature of the illumination device 130C (light source 136C), which is detected by a temperature sensor not shown in the figure, is also output to the transmission unit 134B. The transmission unit 134B outputs a signal including the illumination ID information and information relating to the cumulative ON time, post-cold start ON time, and temperature at predetermined time intervals. In the example shown in FIG. 14, this signal is output wirelessly, but the signal may be output using wired communication means such as PLC.

In the description of the monitor profile information correction unit 119 (119A) using FIGS. 10, 12 and 13, the elapsed time measurement unit of the display monitor was not mentioned in detail, but by providing a similar configuration to the elapsed time measurement unit 139 described above in the display monitor 120, the cumulative use time and post-cold start elapsed time can be measured, and the measurement results can be output to the monitor profile information correction unit 119 via the monitor profile information memory 122 and monitor profile information receiving unit 116.

In the video display system 100D according to the third embodiment of this invention, similarly to the first embodiment described above, signals may be communicated between the illumination device 130 and the video signal processing device 110C using a wired system. Furthermore, the video signal processing device 110C may be built into the display monitor 120. Moreover, similarly to the aspect described with reference to FIG. 6, the video display system 100D according to the third embodiment may comprise a plurality of types of light sources having different illumination spectra.

In the first through third embodiments described above, examples were described in which the video signal conversion unit 114 performs color conversion processing on the video signal on the basis of the illumination profile information such that the coloring of the displayed object is simulated as if the object were placed at the disposed location of the display monitor. However, as color conversion processing based on the illumination profile information, the simulation described above need not be performed, and instead, only processing to reduce the effect of at least one of the ambient light adaptation and display surface reflection described above may be performed.

The video signal processing technique according to this invention may be used in an image projecting device such as a television receiver, a video monitor, a computer monitor, or a data projector, and so on.

The entire contents of Japanese Patent Application JP2007-91069 (filed on Mar. 30, 2007) are incorporated herein by reference.

What is claimed is:

1. A video signal processing device for processing a video signal input into a display monitor, comprising:
an illumination profile information input unit that inputs illumination profile information, which is information relating to an illumination spectral characteristic of an illumination device that illuminates the periphery of the display monitor, from the illumination device;
a monitor profile information input unit that inputs monitor profile information, which is information relating to a display profile of the display monitor, from the display monitor; and
a video signal conversion unit that performs color correction on a video image displayed on the display monitor by performing the video signal to color conversion processing on the basis of the illumination profile information and the monitor profile information.

2. The video signal processing device as defined in claim 1, wherein the illumination profile information input unit is configured to be capable of inputting the illumination profile information from the illumination device using either a wireless manner or a wired manner.

3. The video signal processing device as defined in claim 1, wherein the illumination device includes a plurality of types of light sources having different illumination spectral characteristics, and the illumination profile information input unit is configured to input the illumination profile information of an activated light source from among the plurality of types of light sources.

4. The video signal processing device as defined in claim 1, wherein the illumination profile information is illumination ID information with which a product type of the illumination device can be specified,
the video signal processing device further comprises an information search and extraction unit that accesses a database in which the correspondence between the illumination ID information and illumination spectral characteristics is stored, searches for an illumination spectral characteristic corresponding to the illumination ID information, and extracts the illumination spectral characteristic.

5. The video signal processing device as defined in claim 3, wherein the illumination profile information is illumination ID information with which a product type of the illumination device can be specified,
the video signal processing device further comprises an information search and extraction unit that accesses a database in which the correspondence between the illumination ID information and illumination spectral characteristics is stored, searches for an illumination spectral characteristic corresponding to the illumination ID information, and extracts the illumination spectral characteristic.

6. The video signal processing device as defined in claim 4, wherein the illumination device is configured such that a light source thereof can be replaced, and
the illumination device is also configured to be capable of reading the illumination ID information recorded on or provided to the attached light source, and outputting the read illumination ID information.

7. The video signal processing device as defined in claim 1, further comprising an illumination profile information correction unit that corrects a conversion parameter used in the color conversion processing of the video signal on the basis of detection results of a cumulative ON time of the illumination device, an elapsed time following a cold start of the illumination device, and a temperature of the periphery of the illumination device.

8. The video signal processing device as defined in claim 3, further comprising an illumination profile information correction unit that corrects a conversion parameter used in the color conversion processing of the video signal on the basis of detection results of a cumulative ON time of the illumination device, an elapsed time following a cold start of the illumination device, and a temperature of the periphery of the illumination device.

9. The video signal processing device as defined in claim 4, further comprising an illumination profile information correction unit that corrects a conversion parameter used in the color conversion processing of the video signal on the basis of detection results of a cumulative ON time of the illumination device, an elapsed time following a cold start of the illumination device, and a temperature of the periphery of the illumination device.

10. The video signal processing device as defined in claim 6, wherein the illumination device comprises an illumination time measurement unit that detects a cumulative ON time and an elapsed time following a cold start of the illumination device.

11. The video signal processing device as defined in claim 10, wherein the illumination device is configured such that the light source thereof can be replaced, and
the illumination time measurement unit is configured such that after the light source is replaced with a new one, the cumulative ON time is initialized when the new light source is first switched ON.

12. The video signal processing device as defined in claim 1, further comprising a monitor profile information correction unit that corrects a conversion parameter used in the color conversion processing of the video signal on the basis of detection results of a cumulative use time of the display monitor, an elapsed time following a cold start, and a temperature of the periphery of the display monitor.

13. The video signal processing device as defined in claim 12, wherein the display monitor comprises a monitor time measurement unit that detects a cumulative use time and an elapsed time following a cold start of the display monitor.

14. A video signal processing method for processing a video signal input into a display monitor, comprising:
inputting illumination profile information, which is information relating to an illumination spectral characteristic of an illumination device that illuminates the periphery of the display monitor, from the illumination device;
inputting monitor profile information, which is information relating to a display profile of the display monitor, from the display monitor; and
performing color correction on a video image displayed on the display monitor by performing the video signal to color conversion processing on the basis of the illumination profile information and the monitor profile information.

15. The video signal processing method as defined in claim 14, wherein the illumination device includes a plurality of types of light sources having different illumination spectral characteristics, and inputting the illumination profile information comprises inputting the illumination profile information of an activated light source from among the plurality of types of light sources.

16. The video signal processing method as defined in claim 14, wherein the illumination profile information is illumination ID information from which a product type of the illumination device can be specified,
the video signal processing method further comprises accessing a database in which the correspondence between the illumination ID information and illumination spectral characteristics is stored, searching for an illumination spectral characteristic corresponding to the illumination ID information, and extracting the illumination spectral characteristic.

17. A video display system comprising:
the video signal processing device as defined in claim 1;
a display monitor configured to be capable of outputting the monitor profile information to the video signal processing device; and
an illumination device that illuminates the periphery of the display monitor and is configured to be capable of outputting the illumination profile information to the video signal processing device.

18. The video display system as defined in claim 17, wherein the illumination device includes a plurality of types of light sources having different illumination spectral characteristics, and the illumination profile information input unit is configured to input the illumination profile information of an activated light source from among the plurality of types of light sources.

19. The video display system as defined in claim 17, wherein the illumination profile information is illumination ID information from which a product type of the illumination device can be specified, and
the video signal processing device further comprises an information search and extraction unit that accesses a database in which the correspondence between the illumination ID information and illumination spectral characteristics is stored, searches for an illumination spectral characteristic corresponding to the illumination ID information, and extracts the illumination spectral characteristic.

20. The video display system as defined in claim 17, wherein the illumination device is configured such that a light source thereof can be replaced, and
the illumination device is also configured to be capable of reading the illumination ID information recorded on or provided to the attached light source, and outputting the read illumination ID information.

21. The video display system as defined in claim 17, wherein the video signal processing device further comprises an illumination profile information correction unit that corrects a conversion parameter used in the color conversion processing of the video signal on the basis of detection results of a cumulative ON time of the illumination device, an elapsed time following a cold start of the illumination device, and a temperature of the periphery of the illumination device.
